(19) United States
(12) Patent Application Publication
(10) Pub. No.: US 2005/0077653 A1
(43) Pub. Date: Apr. 14, 2005

(54) Method for producing shaped parts with a small flash

(76) Inventors: Klink Holger, Muhltal (DE); Frank Reil, Seeheim-Jugenheim (DE)

Correspondence Address: CONNOLLY BOVE LODGE & HUTZ, LLP, P O BOX 2207, WILMINGTON, DE, 19899, US

(21) Appl. No.: 10/479,133

(22) PCT Filed: May 28, 2002
(86) PCT No.: PCT/EP02/05852

(30) Foreign Application Priority Data
May 31, 2001 (DE) 101 26 629.4

(51) Int. Cl. B29C 45/00; C08J 5/00

(52) U.S. Cl. 264/328.17; 264/331.11

(57) ABSTRACT

The present invention relates to a process for producing moldings from polyarylene sulfides, in particular polyphenylene sulfide, the result of which can be a particularly low level of flash formation.

The present invention relates to a process for producing moldings from polyarylene sulfides, in particular polyphenylene sulfide, the result of which can be a particularly low level of flash formation.

The formation of flash from polyarylene sulfides constantly leads to problems during injection molding of these materials. These are caused by the low viscosity of the material and its low crystallization rate. To eliminate this problem, high precision requirements are placed upon the injection molds used for polyarylene sulfides. The deaeration of the mold has to be very effective, and to this end numerous deaeration channels of a particular shape are produced with high precision. High locking forces have to be used during the actual injection molding procedure.

DE 41 28 079 describes mixtures made from polyarylene sulfides comprising novolak-type condensates, where formation of flash is reduced.

Surprisingly, it has been found that when moldings are produced from polyarylene sulfides by the MuCell process, and with the resultant further lowering of the melt viscosity of the moldings, the formation of flash has been markedly reduced. The invention therefore provides a process for producing moldings from polyarylene sulfides with reduced formation of flash, which comprises producing a homogeneous melt from polyarylene sulfides, dissolving in the polyarylene sulfide melt up to 30% by weight, based on the melt, of a fluid which is above its critical point under the plastifying conditions for polyarylene sulfide, and charging the mixture to an injection mold. During the charging procedure, bubbles form in the mixture as it solidifies, and when the material solidifies in the injection mold the molding produced has a reduced level of flash formation.

The present invention also provides the moldings produced by the process.

The formation of flash is reduced by the process of the invention to the extent that it is possible to reduce, or completely omit, downstream mechanical operations on injection moldings to remove flash.

In the present process, a homogeneous melt of polyarylene sulfides is produced, and up to 30% by weight, preferably 5 to 27% by weight, particularly preferably from 7 to 23% by weight, in particular from 7 to 21% by weight of a fluid which is in the supercritical state. The fluid and the polyarylene sulfide melt are, where appropriate, sheared and mixed by well-known processes, for example in an extruder or a kneader, whereupon the fluid dissolves in the polyarylene sulfide melt. The selected amount of the fluid is such that the solution of the fluid in the polyarylene sulfide melt has a viscosity which is up to 60% below the viscosity of the pure polyarylene sulfide melt. The selected amount of the fluid may be such that the desired viscosity is achieved. The mixture is rapidly charged to an injection mold. The holding pressure may be reduced as far as zero, and is supplanted by the gas pressure. The selected injection pressure is generally up to 45%, advantageously up to 30%, in particular up to 20%, below the injection pressure usually needed when using a polyarylene sulfide melt. The locking force for the mold may be lowered to up to 30%, advantageously up to 25%, in particular up to 10%, compared with that in the known processes using a pure polyarylene sulfide melt and is generally in the range from 0.05 to 1 t/cm², advantageously from 0.1 to 0.7 t/cm², in particular from 0.12 to 0.61 t/cm².

In principle, any of the suitable fluids may be used as fluid, but preference is given to atmospheric gases, in particular carbon dioxide and nitrogen.

According to the invention, any of the thermoplastic polyarylene sulfides known per se may be used. Suitable materials are described by way of example in Saechtling, Kunststoff-Taschenbuch [Plastics Handbook], Hanser-Verlag, 27^{th} edition, pp. 495-498, incorporated herein by way of reference. Polyphenylene sulfide, PPS, is advantageous.

Polyarylene sulfides may be prepared via dihalogenated aromatic compounds. Preferred dihalogenated aromatic compounds are p-dichlorobenzene, m-dichlorobenzene, 2,5-dichlorotoluene, p-dibromobenzene, 1,4-dichloronaphthalene, 1-methoxy-2,5-dichlorobenzene, 4,4′-dichlorobiphenyl, 3,5-dichlorobenzoic acid, 4,4′-dichlorodiphenyl ether, 4,4′-dichlorodiphenyl sulfone, 4,4′-dichlorodiphenyl sulfoxide and 4,4′-dichlorodiphenyl ketone. Small amounts of other halogenated compounds, such as trihalogenated aromatics, may also be used in order to control the properties of the polymer as desired.

According to the invention, polyphenylene sulfide is preferably used as polyarylene sulfide. Polyphenylene sulfide (PPS) is a semicrystalline polymer having the formula: 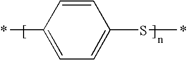
where n>1 and the molar mass (M_{w}) of the polymer is at least 200 g/mol.

The polyarylene sulfide may also comprise conventional additives and reinforcing materials, e.g. fibers, in particular glass fibers, carbon fibers, aramid fibers, mineral fibers, processing aids, polymeric lubricants, lubricants with external and/or internal lubricant action, ultrahigh-molecular-weight polyethylene (UHMWPE), polytetrafluoroethylene (PTFE), or a graft copolymer which is a product of a graft reaction of an olefin polymer and an acrylonitrile-styrene copolymer, antioxidants, coupling agents, waxes, nucleating agents, mold-release aids, glass beads, mineral fillers, such as chalk, calcium carbonate, wollastonite, silicon dioxide, talc, mica, montmorillonite, organically modified or unmodified, organically modified or unmodified phyllosilicates, materials which form nanocomposites with the liquid-crystalline plastic or with the polyarylene sulfide, or nylon nanocomposites, or mixtures of the abovementioned substances.

The lubricants used may comprise a mixture of a lubricant with external lubricating action and a lubricant with internal lubricating action. The mixing ratio of lubricant with internal lubricating action to the lubricant with external lubricating action may be from 0:100 to 100:0 part by weight. The lubricants used with predominantly external lubricating action may comprise solid and/or liquid paraffins, montanic esters, partially hydrolyzed montanic esters, stearic acids, polar and/or nonpolar polyethylene waxes, poly-α-olefin oligomers, silicone oils, polyalkylene glycols, and perfluoroalkyl ethers. Soaps and esters, including those which have been partially hydrolyzed, are lubricants with both external and internal lubricating action. Preference is given to the use of a high-molecular-weight polyethylene wax which has been oxidized and is therefore polar. It improves tribological behavior and permits the fall-off in mechanical properties to be less marked. Stearyl stearate is preferably used as lubricant with predominantly internal lubricating action.

Paraffins, solid or liquid, stearic acids, polyethylene waxes, nonpolar or polar, poly-α-olefin oligomers, silicone oils, polyalkylene glycols, and perfluoroalkyl ethers are lubricants with external lubricating action. Soaps and esters, including those which have been partially hydrolyzed, are lubricants with both external and internal lubricating action. Montanic esters and partially hydrolyzed montanic esters are lubricants with external lubricating action.

The preferred oxidized polyethylene wax is a high-molecular-weight, polar wax and generally has an acid value of from 12 to 20 mg KOH/g and a viscosity of from 3000 to 5000 mPa.s at 140° C.

Mention should be made of the following lubricants with predominantly internal lubricating action: fatty alcohols, dicarboxylic esters, fatty esters, fatty acid, fatty-acid soaps, fatty amide, wax esters, and stearyl stearates, the last-named being preferred. Lubricants are described in Gächter/Müller, “Taschenbuch der Kunststoff-Additive” [Handbook of Plastics Additives], 3^{rd} edition, Carl Hanser Verlag Munich/Vienna 1994, pp. 478-504, incorporated herein by way of reference.

1-6. (canceled)

7. A process for producing moldings which comprises injection molding polyarylene sulfides with reduced formation of flash, which comprises producing a homogeneous melt from polyarylene sulfides, dissolving in the polyarylene sulfide melt up to 30% by weight of a fluid which is above its critical point under the plastifying conditions for polyarylene sulfide, and charging the mixture to an injection mold.

8. The process as claimed in claim 7, wherein the selection of the amount of the fluid is such that the viscosity of the polyarylene sulfide melt with dissolved fluid is up to 60% below the viscosity of the pure polyarylene sulfide melt at the same temperature and shear rate.

9. The process as claimed in claim 7, wherein said polyarylene sulphide is polyphenylene sulfide.

10. The process as claimed in claim 8, wherein said polyarylene sulphide is polyphenylene sulfide.

11. The process as claimed in claim 7, wherein the locking force for the injection mold is in the range from 0.05 to 1 t/cm², and/or not more than 30% of the locking force used when using a pure polyarylene sulfide melt.

12. The process as claimed in claim 10, wherein the locking force for the injection mold is in the range from 0.05 to 1 t/cm², and/or not more than 30% of the locking force used when using a pure polyarylene sulfide melt.

13. The process as claimed in claim 7, wherein said fluid is nitrogen or carbon dioxide.

14. The process as claimed in claim 12, wherein said fluid is nitrogen or carbon dioxide.

15. A molding obtained by a process as claimed in claim 7.

16. A molding obtained by a process as claimed in claim 14.
